(19) United States
(12) Patent Application Publication
(10) Pub. No.: US 2025/0222486 A1
(43) Pub. Date: Jul. 10, 2025

(54) Optical Article Coating System

(71) Applicant: Transitions Optical, Ltd., Tuam (IE)

(72) Inventors: Lawrence M. Minor, McKinney, TX (US); Willard Beamer, Palmetto, FL (US); Steven Cicco, Flower Mound, TX (US); Lex Pace, Largo, FL (US); Yani Saputera, The Colony, TX (US); Kyle Henderson, Dallas, TX (US)

(21) Appl. No.: 18/849,588

(22) PCT Filed: Mar. 24, 2022
(86) PCT No.: PCT/EP2022/057842

§ 371 Date: Sep. 23, 2024

(51) Int. Cl. B05C 11/10; B01D 19/00; B01D 36/00; B05C 9/10; B05C 9/12; B05C 11/08; B05C 11/11; B05C 13/02

(52) U.S. Cl. CPC B05C 11/1002; B01D 19/0042; B01D 19/0068; B01D 36/001; B05C 9/10; B05C 9/12; B05C 11/08; B05C 11/11; B05C 13/025

(57) ABSTRACT

A coating system for coating an optical article includes at least one replaceable cartridge having a reservoir configured for containing a volume of a coating material. a recirculation loop in fluid communication with the reservoir, and a first pump and a second pump in fluid communication with the recirculation loop. The coating system further includes at least one coating apparatus operable to coat at least a portion of the optical article with a select amount of the coating material from an engaged at least one replaceable cartridge. The second pump of each of the engaged at least one replaceable cartridge is operable to aspirate the select amount of the coating material from the recirculation loop and deliver the select amount of the coating material to the at least one coating apparatus.

### BACKGROUND OF THE INVENTION

### Field of the Invention

The present invention relates to a coating system for coating an optical article. In particular, the present invention relates to a coating system for coating an optical article having at least one replaceable cartridge having a reservoir configured for containing a volume of a coating material and at least one coating apparatus operable to coat at least a portion of the optical article with a select amount of the coating material from the at least one replaceable cartridge. A method of coating an optical article using a coating system is also disclosed.

### Description of the Related Art

With optical articles, such as lenses, one or more surfaces may be subjected to a treatment to enhance the overall performance and function of the optical articles. Examples of such treatments include the formation of one or more coatings on a surface of an optical article.

In order to manufacture a coated optical article from an uncoated optical article, a variety of manufacturing techniques have been developed. For smaller batches, it may be economical to manufacture coated optical articles by passing a single optical article through a plurality of discrete processing stations, such as a washing station, a coating station, and a curing station, before a subsequent optical article is processed. Small batch coating systems are typically configured for application of a single coating material. In large scale operations, optical articles may be processed on an automated production line configured for processing hundreds of optical articles per hour.

Regardless of the manufacturing scale, it is difficult to quickly switch the production line for the application of different coating materials, such as for different substrates and/or different final products, as generally the coating material reservoir and the coating apparatus must be purged and cleaned to accommodate the change in coating material. An additional difficulty relates to the curing station, which may not be suitable for curing other coating materials.

It would be desirable to develop coating systems that can accommodate a plurality of different coating materials. It would be further desirable that such newly developed coating systems are configured for quick and easy switching between different coating materials.

### SUMMARY OF THE INVENTION

In some non-limiting examples or aspects of the present disclosure, provided is a coating system for coating an optical article that may include at least one replaceable cartridge having a reservoir configured for containing a volume of a coating material, a recirculation loop in fluid communication with the reservoir, and a first pump and a second pump in fluid communication with the recirculation loop. The coating system further may include at least one coating apparatus operable to coat at least a portion of the optical article with a select amount of the coating material from an engaged at least one replaceable cartridge. The second pump of each of the engaged at least one replaceable cartridge may be operable to aspirate the select amount of the coating material from the recirculation loop and deliver the select amount of the coating material to the at least one coating apparatus.

In some non-limiting examples or aspects of the present disclosure, the first pump may be a diaphragm pump configured for recirculating the coating from the reservoir through the recirculation loop. The second pump may be a piston pump having housing that includes an inlet having an inlet valve, an outlet having an outlet valve, and a pumping chamber between the inlet valve and the outlet valve. The second pump further may include a piston disposed within the pumping chamber and configured for reciprocal movement within the pumping chamber via a drive member.

In some non-limiting examples or aspects of the present disclosure, the at least one coating apparatus may include a first coating apparatus and a second coating apparatus each selectively operable to coat at least a portion of the optical article with the select amount of the coating material from the engaged at least one coating reservoir. The first coating apparatus may include an ultrasonic discharge nozzle configured for atomizing the select amount of coating material from the engaged at least one coating reservoir. The second coating apparatus may be a spin coating apparatus.

In some non-limiting examples or aspects of the present disclosure, a marking apparatus may be configured for marking at least one surface of the optical article with at least one mark. Furthermore, an identification apparatus configured for identifying an orientation of the at least one mark may be provided. The coating system may include a placement arm configured to move the optical article from the identification apparatus to the at least one coating apparatus and position the optical article at a predetermined orientation relative to at least one coating apparatus based on the orientation of the at least one mark.

In some non-limiting examples or aspects of the present disclosure, the coating system may include a pre-treatment station, wherein the pre-treatment station is configured for raising wettability of the optical article to promote adhesion of the at least one coating material with the optical article. The coating system further may include a cleaning station a housing having a wash bowl and a lid for enclosing the wash bowl, a spin platform within the wash bowl configured for receiving the optical article, and at least one wash nozzle configured for cleaning at least one surface of the optical article with a pressurized liquid. The bowl may include an air inlet configured for directing air toward the spin platform, an air outlet configured for exhausting the air from the wash bowl, and a diffuser between the air inlet and the air outlet.

In some non-limiting examples or aspects of the present disclosure, the coating apparatus may include at least one curing station, where each curing station is independently configured to at least partially cure the at least one coating material applied to the optical article. Each curing station independently may include at least one of (i) a thermal curing station; (ii) a UV curing station; (iii) an IR curing station; and (iv) combinations of at least two of (i), (ii), and (iii).

In some non-limiting examples or aspects of the present disclosure, the coating apparatus may include a filter in fluid communication with the recirculation loop, wherein the filter is configured for filtering the coating material circulating through the recirculation loop. The coating apparatus may include a de-bubbling system in fluid communication with the recirculation loop, the de-bubbling system configured for removing air bubbles in the coating material circulating through the recirculation loop.

A coating system for coating an optical article may be characterized by one or more of the following aspects.

In a first aspect, the coating system for coating an optical article may have at least one replaceable cartridge comprising a reservoir configured for containing a volume of a coating material, a recirculation loop in fluid communication with the reservoir, and a first pump and a second pump in fluid communication with the recirculation loop; and at least one coating apparatus operable to coat at least a portion of the optical article with a select amount of the coating material from an engaged at least one replaceable cartridge, wherein the second pump of each of the engaged at least one replaceable cartridge is operable to aspirate the select amount of the coating material from the recirculation loop and deliver the select amount of the coating material to the at least one coating apparatus.

In a second aspect, in the coating system in accordance with the first aspect, the first pump is a diaphragm pump configured for recirculating the coating from the reservoir through the recirculation loop.

In a third aspect, in the coating system in accordance with the first aspect or the second aspect, the second pump is a piston pump comprised of a piston disposed within a pumping chamber and configured for reciprocal movement within the pumping chamber via a drive member.

In a fourth aspect, in the coating system in accordance with any one of the first aspect to the third aspect, the at least one coating apparatus comprises a first coating apparatus and a second coating apparatus each selectively operable to coat at least a portion of the optical article with the select amount of the coating material from the engaged at least one coating reservoir.

In a fifth aspect, in the coating system in accordance with the fourth aspect, the first coating apparatus comprises an ultrasonic discharge nozzle configured for atomizing the select amount of coating material from the engaged at least one coating reservoir.

In a sixth aspect, in the coating system in accordance with the fourth aspect or the fifth aspect, the second coating apparatus is a spin coating apparatus.

In a seventh aspect, in the coating system in accordance with any of one of the first aspect to the sixth aspect, provided are a marking apparatus configured for marking at least one surface of the optical article with at least one mark; and an identification apparatus configured for identifying the at least one mark, wherein the at least one mark contains information for processing the optical article in the coating system.

In an eighth aspect, in the coating system in accordance with the seventh aspect, provided is a placement arm configured to move the optical article from the identification apparatus to the at least one coating apparatus and position the optical article at a predetermined orientation relative to at least one coating apparatus based on the at least one mark.

In a ninth aspect, in the coating system in accordance with any one of the first aspect to the eighth aspect, provided is a pre-treatment station, wherein the pre-treatment station is configured for raising wettability of the optical article to promote adhesion of the at least one coating material with the optical article.

In a tenth aspect, in the coating system in accordance with any one of the first aspect to the ninth aspect, provided is a cleaning station comprising: a housing having a wash bowl and a lid for enclosing the wash bowl; a spin platform within the wash bowl configured for receiving the optical article; and at least one wash nozzle configured for cleaning at least one surface of the optical article with a pressurized liquid.

In an eleventh aspect, in the coating system in accordance with the tenth aspect, the wash bowl comprises an air inlet configured for directing air toward the spin platform, an air outlet configured for exhausting the air from the wash bowl, and a diffuser between the air inlet and the air outlet.

In a twelfth aspect, in the coating system in accordance with any one of the first aspect to the eleventh aspect, provided is at least one curing station, where each curing station is independently configured to at least partially cure the at least one coating material applied to the optical article.

In a thirteenth aspect, in the coating system in accordance with the twelfth aspect, each curing station independently comprises at least one of (i) a thermal curing station; (ii) a UV curing station; (iii) an IR curing station; and (iv) combinations of at least two of (i), (ii), and (iii).

In a fourteenth aspect, in the coating system in accordance with any one of the first aspect to the thirteenth aspect, provided is a filter in fluid communication with the recirculation loop, wherein the filter is configured for filtering the coating material circulating through the recirculation loop.

In a fifteenth aspect, in the coating system in accordance with any one of the first aspect to the fourteenth aspect, provided is a de-bubbling system in fluid communication with the recirculation loop, the de-bubbling system configured for removing air bubbles in the coating material circulating through the recirculation loop.

The features that characterize the present invention are pointed out with particularity in the claims, which are annexed to and form a part of this disclosure. These and other features of the invention, its operating advantages, and the specific objects obtained by its use will be more fully understood from the following detailed description in which non-limiting examples of the invention are illustrated and described.

### BRIEF DESCRIPTION OF THE DRAWINGS

FIG. 1 is a representative schematic view of a coating system in accordance with some examples of the present disclosure;

FIG. 2 is a representative perspective view of an optical article;

FIG. 3 is a representative perspective view of a washing and drying apparatus in accordance with some examples of the present disclosure;

FIG. 4 is a side cross-sectional view of the washing and drying apparatus shown in FIG. 3;

FIG. 5A is a detailed view of a nozzle of the washing and drying apparatus shown in FIG. 3;

FIG. 5B is a detailed view of a brush of the washing and drying apparatus shown in FIG. 3;

FIG. 6 is a side cross-sectional view of a first coating apparatus in accordance with some examples of the present disclosure;

FIG. 7 is a side cross-sectional view of a second coating apparatus in accordance with some examples of the present disclosure;

FIG. 8 is a representative schematic view of a coating material storage system for use with the coating system of FIG. 1;

FIG. 9 is a perspective view of a replaceable cartridge configured for use with the coating material storage system of FIG. 8;

FIG. 10 is a perspective view of a first pump of the replaceable cartridge shown in FIG. 9;

FIG. 11 is a perspective cross-sectional view of the first pump shown in FIG. 10;

FIG. 12 is a side cross-sectional view of a second pump of the replaceable cartridge shown in FIG. 9; and

FIG. 13 is a side cross-sectional view of a curing apparatus in accordance with some examples of the present disclosure.

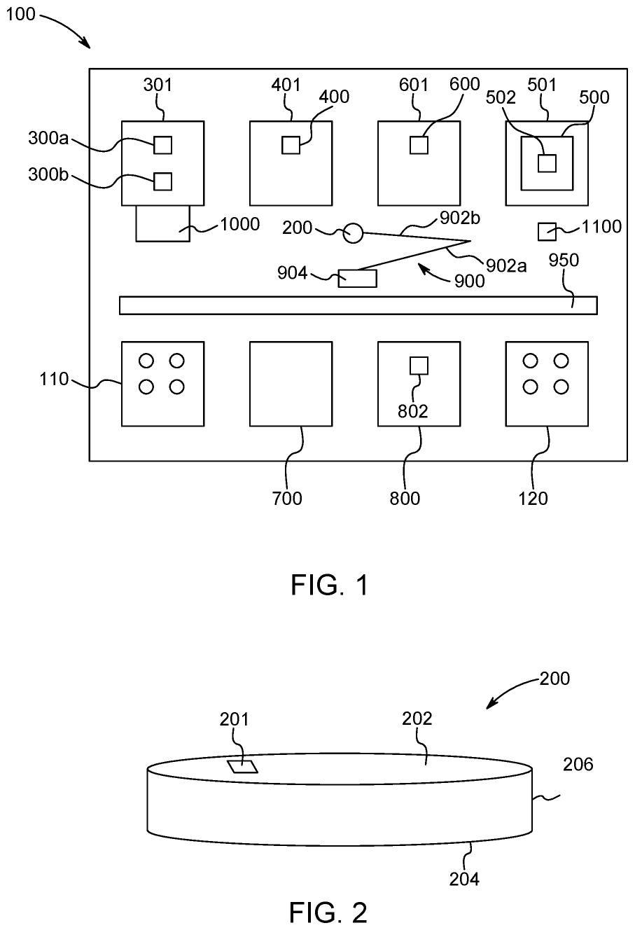

In FIGS. 1-13, like characters refer to the same components and elements, as the case may be, unless otherwise stated.

### DETAILED DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

All numbers used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, or C” includes A alone; or B alone; or C alone; or A and B; or A and C; or B and C; or all of A, B, and C.

The term “adjacent” means proximate to but not in direct contact with.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The term “optical” means pertaining to or associated with light and/or vision. For example, an optical element, article, or device can be chosen from ophthalmic elements, articles, and devices; display elements, articles, and devices; visors; windows; and mirrors.

The term “ophthalmic” means pertaining to or associated with the eye and vision. Non-limiting examples of ophthalmic articles or elements include corrective and non-corrective lenses, including single vision or multi-vision lenses, which may be either segmented or non-segmented multi-vision lenses (such as, but not limited to, bifocal lenses, trifocal lenses, and progressive lenses), as well as other elements used to correct, protect, or enhance (cosmetically or otherwise) vision, including without limitation, contact lenses, intra-ocular lenses, magnifying lenses, and protective lenses or visors.

As used herein, the terms “lens” and “lenses” mean and encompass at least individual lenses, lens pairs, partially formed (or semi-finished) lenses, fully formed (or finished) lenses, and lens blanks.

As used herein, the term “transparent”, such as used in connection with a substrate, film, material, and/or coating, means that the indicated substrate, film, material, and/or coating has the property of transmitting visible light without appreciable scattering so that objects lying beyond are visibly observable.

As used herein, the terms “ultraviolet”, “UV”, “ultraviolet light”, or “ultraviolet radiation” mean electromagnetic radiation having a wavelength in the range of 10 nm to 400 nm.

As used herein, the terms “infrared”, “IR”, “infrared light”, or “infrared radiation” mean electromagnetic radiation having a wavelength in the range of 780 nm to 1 mm.

As used herein, the term “ultrasonic” refers to one or more sound waves having a frequency higher than approximately 20,000 Hz (20 kHz).

As used herein, the term “coating” means a supported film derived from a flowable coating material, which can optionally have a uniform thickness, and specifically excludes polymeric sheets. The terms “layer” and “film” each encompass both coatings (such as a coating layer or a coating film) and sheets, and a layer can include a combination of separate layers, including sub-layers and/or over-layers. The verb “coating” means, within appropriate context, the process of applying a coating material (or materials) to the substrate to form a coating (or coating layer).

As used herein, the terms “cure”, “cured”, and related terms, mean that at least a portion of the polymerizable and/or crosslinkable components that form a curable composition are at least partially polymerized and/or crosslinked. In accordance with some examples, the degree of crosslinking can range from 5% to 100% of complete crosslinking. In accordance with some further examples, the degree of crosslinking can range from 30% to 95%, such as 35% to 95%, or 50% to 95%, or 50% to 85% of complete crosslinking. The degree of crosslinking can range between any combination of these recited lower and upper values, inclusive of the recited values.

As used herein, the terms “communication” and “communicate” may refer to the reception, receipt, transmission, transfer, provision, and/or the like, of information (e.g., data, signals, messages, instructions, commands, and/or the like).

As used herein, a “graphical user interface” or “GUI” refers to a generated display with which a user may interact, either directly or indirectly (e.g., through a button, keyboard, mouse, touchscreen etc.).

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

The invention comprises, consists of, or consists essentially of the following examples of the invention, in any combination. Various examples of the invention may be discussed separately. However, it is to be understood that this is simply for ease of illustration and discussion. In the practice of the invention, one or more aspects of the invention described in one example can be combined with one or more aspects of the invention described in one or more of the other examples.

With reference to FIG. 1, a coating system 100 is shown in accordance with some examples or aspects of the present disclosure. The coating system 100, as described herein, and in accordance with some examples, provides a low cost, small scale coating system configured for applying one or more coating materials to an optical article 200. The coating system 100 can include a surface pretreatment station (such as, but not limited to, a plasma pretreatment station), a washing/drying station, one or more coating apparatuses (utilizing one or more of multiple coatings and combinations of coatings), and one or more curing apparatuses (such as UV, IR, and/or thermal curing apparatuses) or combinations thereof. The coating system 100 of the present invention can, with some examples, be operated with the formation of minimal waste streams and/or waste materials.

The coating system 100 of the present disclosure can, with some examples, be used for the production of optical articles 200, which each independently have the same or different coating materials applied thereon. In some examples, the coating system 100 of the present disclosure can be at least partially automated and optionally incorporated into art-recognized product tracking and control systems.

With reference to FIG. 1, the coating system 100 generally has a plurality of stations, each having an apparatus configured for performing a specified task. For example, the coating system 100 may have a coating station 301 having at least one coating apparatus 300 for coating the optical article 200 and a curing station 401 having at least one curing apparatus 400 for curing the coated optical article 200. Optionally, the coating system 100 has a pre-treatment station 500, and/or a washing and drying station 600. In some examples or aspects, the coating system 100 may have a marking station 700 configured for marking at least one mark on the optical article 200 and an inspection station 800 configured for determining at least one characteristic of the at least one mark on the optical article 200. A placement arm 900 may be provided for moving the optical article 200 between various stations of the coating system 100. In some examples or aspects, a conveyor belt 950 may be provided for moving the optical articles 200 between different stations of the coating system 100 or within any single station of the coating system 100.

With continued reference to FIG. 1, the coating system 100 may have a loading station 110 having a plurality of blank optical articles 200 that are to be processed through the coating system 100. The coating system 100 further may include an unloading station 120 configured for storing one or more coated optical articles 200 after the one or more optical articles 200 have been processed through the coating system 100.

The coating system 100 can, with some examples or aspects, be used to coat a variety of articles, such as, but not limited to, optical articles 200. With reference to FIG. 2, the optical article 200 has a forward or top surface 202, a rearward or bottom surface 204, and a side surface 206 extending between the top surface 202 and the bottom surface 204. When the optical article 200 is an ophthalmic lens, the bottom surface 204 is opposed to the eye of an individual wearing the optical article 200, the side surface 206 typically resides within a supportive frame, and the top surface 2202 faces incident light (not shown), at least a portion of which passes through the optical article 200 and into the individual's eye. With some examples or aspects, at least one of the top surface 202, the bottom surface 204, and the side surface 206 may have various shapes including, but not limited to, round, flat, cylindrical, spherical, planar, substantially planar, plano-concave and/or plano-convex, and curved, including, but not limited to, convex, and/or concave.

The optical article 200 that is coated with the system and method of the present disclosure can, with some examples, be formed from and correspondingly include organic materials, inorganic materials, or combinations thereof (for example, composite materials).

Examples of organic materials that can be used as optical articles 200 in accordance with various examples of the present invention, include polymeric materials, such as homopolymers and copolymers, prepared from the monomers and mixtures of monomers disclosed in U.S. Pat. No. 5,962,617 and in U.S. Pat. No. 5,658,501 from column 15, line 28 to column 16, line 17. For example, such polymeric materials can be thermoplastic or thermoset polymeric materials, can be transparent or optically clear, and can have any refractive index required. Examples of such monomers and polymers include: polyol(allyl carbonate) monomers, e.g., allyl diglycol carbonates such as diethylene glycol bis(allyl carbonate), which monomer is sold under the trademark CR-39 by PPG Industries, Inc.; polyurea-polyurethane (polyurea-urethane) polymers, which are prepared, for example, by the reaction of a polyurethane prepolymer and a diamine curing agent, a composition for one such polymer being sold under the trademark TRIVEX by PPG Industries, Inc.; polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; poly(ethylene glycol) bismethacrylate monomers; urethane acrylate monomers; poly(ethoxylated bisphenol A dimethacrylate); poly(vinyl acetate); poly(vinyl alcohol); poly(vinyl chloride); poly(vinylidene chloride); polyethylene; polypropylene; polyurethanes; polythiourethanes; thermoplastic polycarbonates, such as the carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS, and polymers prepared by reacting polyfunctional isocyanates with polythiols or polyepisulfide monomers, either homopolymerized or co- and/or terpolymerized with polythiols, polyisocyanates, and polyisothiocyanates; and optionally ethylenically unsaturated monomers or halogenated aromatic-containing vinyl monomers. Also contemplated are copolymers of such monomers and blends of the described polymers and copolymers with other polymers, for example, to form block copolymers or interpenetrating network products.

With some examples of the present invention, the optical article 200 can be an ophthalmic article. Examples of organic materials suitable for use in forming ophthalmic articles include art-recognized polymers that are useful as ophthalmic articles, such as organic optical resins that are used to prepare optically clear castings for optical applications, such as ophthalmic lenses.

Examples of inorganic materials that can be used as optical articles 200 with some examples of the present invention include glasses, minerals, ceramics, and metals. With some examples, the optical article 200 can include glass. In other examples, the optical article 200 can have a reflective surface, for example, a polished ceramic substrate, metal substrate, or mineral substrate. In other examples, a reflective coating or layer (e.g., a metal layer, such as a silver layer) can be deposited or otherwise applied to a surface of an inorganic or an organic substrate to make it reflective or to enhance its reflectivity.

Optical articles 200 that can be used with the method according to some examples of the present disclosure can also include untinted, tinted, linearly polarizing, circularly polarizing, elliptically polarizing, photochromic, or tinted-photochromic substrates. As used herein with reference to optical articles 200, the term “untinted” means optical articles that are essentially free of coloring agent additions (such as conventional dyes) and have an absorption spectrum for visible radiation that does not vary significantly in response to actinic radiation. Further, with reference to optical articles 200, the term “tinted” means substrates that have a coloring agent addition (such as conventional dyes) and an absorption spectrum for visible radiation that does not vary significantly in response to actinic radiation.

With continued reference to FIG. 2, at least one indicia, such as at least one mark 210, may be provided on the optical article 200. In some examples or aspects, the at least one mark 210 may be used by the coating system 100 to determine the process flow and process settings that the optical article 200 will undergo in the coating system 100. For example, the at least one mark 210 may define a “recipe” for various treatment steps that the optical article 200 will undergo in the coating system 200. In some examples or aspects, each optical article 200 may have a unique mark 210 that identifies the process flow and process settings that the optical article 200 will undergo in the coating system 100. The use of the at least one mark 210 allows for product tracking within the coating system 100, as well as quality control after the optical articles 200 have been processed through the coating system 100.

In some examples or aspects, the at least one mark 210 may be used to determine an orientation of the optical article 200 relative to at least one component of the coating system 100. In some examples, the at least one mark 210 may be a pair of marks 210 used to identify a location/orientation of at least one characteristic of the optical article 200, such as the progressiveness of the optical article 200 (i.e., location of a smooth transition between parts of the optical article 200 with different focal lengths). Such positioning relative to the coating apparatus is important when applying gradient coatings to the optical article 200. When a gradient coating is applied to a progressive optical article 200, special care must be taken to orient the gradient coating relative to the location of different focal lengths of the optical article 200.

With continued reference to FIG. 2, the at least one mark 210 may be provided on any surface of the optical article 200, such as the top surface 202 the bottom surface 204, and/or the side surface 206. In some examples, the at least one mark 210 is formed as a topographical feature that may protrude from the exterior surface of the optical article 200, or a topographical feature that is recessed into the exterior surface of the optical article 200. In some examples, the at least one mark 210 may be formed on the optical article 200 by etching, engraving, or according to other methods known by those skilled in the field to imprint the desired at least one mark 210 on the optical article 200. In some examples, the at least one mark 210 is in the form of a one-dimensional barcode and/or a two dimensional barcode.

In some examples, the at least one mark 210 may be applied to at least one surface of the optical article 200. For example, the at least one mark 210 may be adhesively applied, printed, written, or otherwise applied to the at least one surface of the optical article 200. In some examples, the at least one mark 210 may be provided on a carrier that is separate from the optical article 200. The carrier may be removably or non-removably applied to at least one surface of the optical article 200.

With reference to FIG. 1, the coating system 100 may have a marking apparatus 700 configured for marking at least one surface of the optical article 200 with the at least one mark 210 (shown in FIG. 2). In some examples or aspects, the marking apparatus 700 may be an engraving apparatus, such as a laser engraving apparatus, configured for marking at least one surface of the optical article 200 with the at least one mark 210. In other examples or aspects, the marking apparatus 700 may be a printer configured for printing a label having the at least one mark 210 which can be adhesively applied to the optical article 200. In some examples or aspects, the marking apparatus 700 that is configured as a printer may be configured for printing the at least one mark 210 directly on at least one surface of the optical article 200. Operation of the marking apparatus 700 may be controlled by a controller, as described hereinafter.

With continued reference to FIG. 1, the coating system 100 has an inspection apparatus 800 configured for identifying the at least one mark 210 (shown in FIG. 2) on the optical article 200. As discussed herein, the at least one mark 210 may be formed directly on the surface of the optical article 200, or it may be formed on a carrier that is removably or non-removably connected to at least one surface of the optical article 200. The inspection apparatus 800 may be used to identify information associated with the at least one mark 210. In some examples or aspects, the inspection apparatus 800 may be configured to determine an orientation of the at least one mark 210 on the optical article 200. Based on the orientation of the at least one mark 210 on the optical article 200, the optical article 200 can be positioned in one or more stations at a predetermined orientation relative to the one or more stations of the coating system 100.

In some examples, the identification apparatus 800 has at least one sensor 802 for identifying the at least one mark 210 on the optical article 200. For example, the at least one sensor 802 may be an optical sensor, such as a camera. The optical sensor 802 may be configured to image the optical article 200. An identification algorithm may be used to identify the at least one mark 210 from the image of the optical article 200 taken by the at least one sensor 802. The identification algorithm may be used, for example, to identify at least one characteristic of the at least one mark 210, such as an orientation of the at least one mark 210 relative to an orientation of a known feature on the inspection apparatus 800. In some examples or aspects, the identification algorithm may be configured to decode information encoded in the at least one mark 210. For example, the at least one mark 210 may contain process flow and settings that the optical article 200 will undergo during the coating process.

With continued reference to FIG. 1, movement of the optical article 200 between various stations of the coating system 100 may be controlled using a placement arm 900. In some examples or aspects, a plurality of placement arms 900 may be provided. The placement arm 900 is configured to engage the optical article 200 in a manner that maintains a known position of the optical article 200 and move the optical article 200 between different stations of the coating system 100. The known position of the optical article 200 can be so maintained as a result of a combination of the accuracy of placement arm 900 and the proper initial positioning of the optical article 200, such as the positioning of the optical article 200 based on the orientation of the at least one mark 210 on the optical article 200.

The placement arm 900 may have one or more sections 902a, 902b that are independently movable relative to a base 904 of the placement arm 900. The one or more sections 902a, 902b may be rotatable or translatable relative to the base 904. The one or more sections 902a, 902b of the placement arm 900 define an envelope in which the placement arm 900 operates to place the optical article 200 at any location within the envelope. Desirably, the placement arm 900 is configured such that all of the stations of the coating system 100 are within the envelope of the placement arm 900. The use of the placement arm 900 allows the coating system 100 to be fully automated within the envelope of the placement arm 900 and minimizes damage to, such as marking of the surfaces of the optical article 200, compared to a manual process, such as a fully manual process.

The optical article 200 can be wet or dry when picked up by the placement arm 900. With some examples, when wet, the optical article 200 includes one or more wet coating layers thereon that are not hard, such as being tacky and/or uncured. With some further examples, when dry, the optical article 200 is free of coating layers or includes one or more dry coating layers that are hard (and not tacky), such as being cured. In various examples, the placement arm 900 is configured for picking up the optical article 200 by contacting at least one surface of the optical article 200.

With continued reference to FIG. 1, the coating system 100 has a pre-treatment station 500 configured for raising wettability of the optical article to promote adhesion of the at least one coating material with the optical article. In some examples or aspects, the pre-treatment station 500 may be a plasma chamber 502. The plasma surface treatment conducted within the plasma chamber 502 can be selected from one or more art-recognized plasma surface treatment methods including, but not limited to, corona treatment, atmospheric plasma treatment, atmospheric-pressure treatment, flame plasma treatment, and/or chemical plasma treatment. With some examples, the surface treatment conducted in the plasma chamber 502 is an oxygen plasma treatment. The surface treatment process involves, with some examples, treating the surface of the optical article 200 to promote wetting and enhance adhesion of a coating that is subsequently applied to and formed thereon. The plasma chamber 502, with some examples, may be operated under conditions of reduced atmosphere, and correspondingly the surface treatment may be conducted as a batch process.

Plasma treatments, including corona treatments, provide a clean and efficient method of altering the surface properties of an optical article 200, such as roughening and/or chemically altering one or more surfaces thereof, without altering the bulk properties of the optical article 200. With some examples, one or more inert gases (such as but not limited to argon and/or nitrogen) and/or one or more reactive gases (such as but not limited to oxygen, CO, and/or CO₂) can be used as the gas in the chamber 62 from which the plasma is formed. Inert gases, with some examples, roughen the surface of optical article 200. Reactive gases such as oxygen, with some examples, can both roughen and chemically alter the surface exposed to the plasma by, for example, forming hydroxyl and/or carboxyl groups on the treated surface.

With some examples, the use of oxygen in the plasma surface treatment process can provide an effective degree of physical roughening and chemical modification of the surface of the optical article 200, which can improve adhesion without detrimentally effecting other properties, such as optical properties, of the optical article 200. Atmospheric air can also be used to form the plasma gas, and with some examples is a reactive gas. The extent of the surface roughening and/or chemical modification is, with some examples, a function of the plasma gas and the operating conditions of the plasma chamber 502, including the length of time of the surface treatment. With some examples, the optical articles 200 are exposed to a plasma surface treatment for 1 to 5 minutes, such as in the plasma chamber 502, which results in the formation of surface treated optical articles 200 that are further processed in the coating apparatus 100. Surface treatment of the optical articles 200 within the plasma chamber 502 can also remove foreign contaminants present on the surface thereof. The presence of certain surface contaminants can, with some examples, undesirably reduce the surface energy of the surface of the optical article 200. A high surface energy, which can result after removal of the surface contaminants, promotes coating wetting, with some examples.

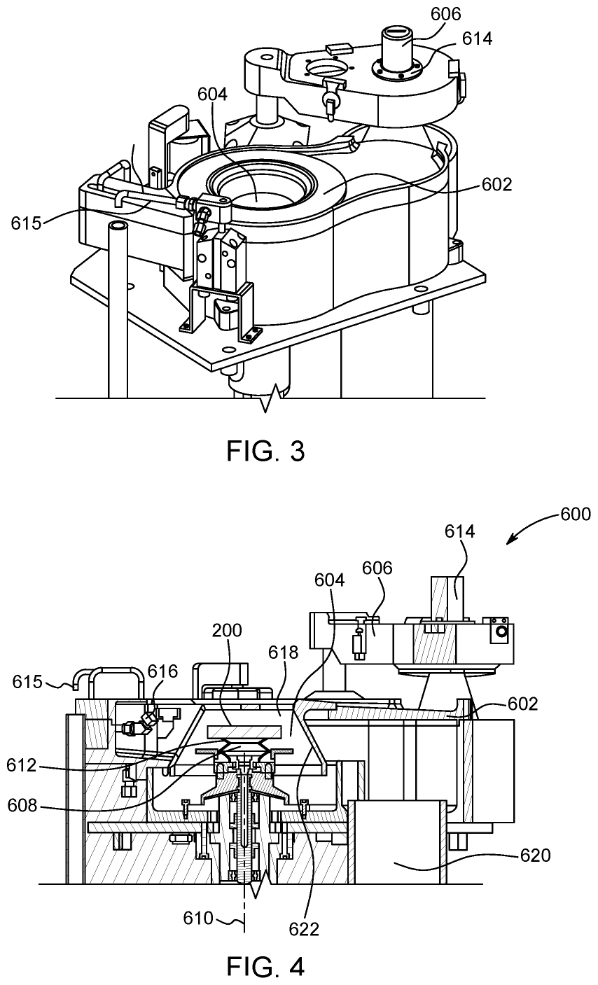

Following the plasma surface treatment in the plasma chamber 502, the surface treated optical articles 200 can be washed in the washing and drying station 600. With reference to FIGS. 3-4, the washing and drying station 600 has housing 602 defining a wash bowl 604. The wash bowl 604 has an open top end that is closable by a lid 606 (shown in FIG. 3). Within the wash bowl 604, a spin platform 608 is provided for receiving the optical article 200 (shown in FIG. 4). The spin platform 608 is rotatable about a rotation axis 610 and has a vacuum chuck 612 that is configured for supporting the optical article 200 on the spin platform 608 via vacuum.

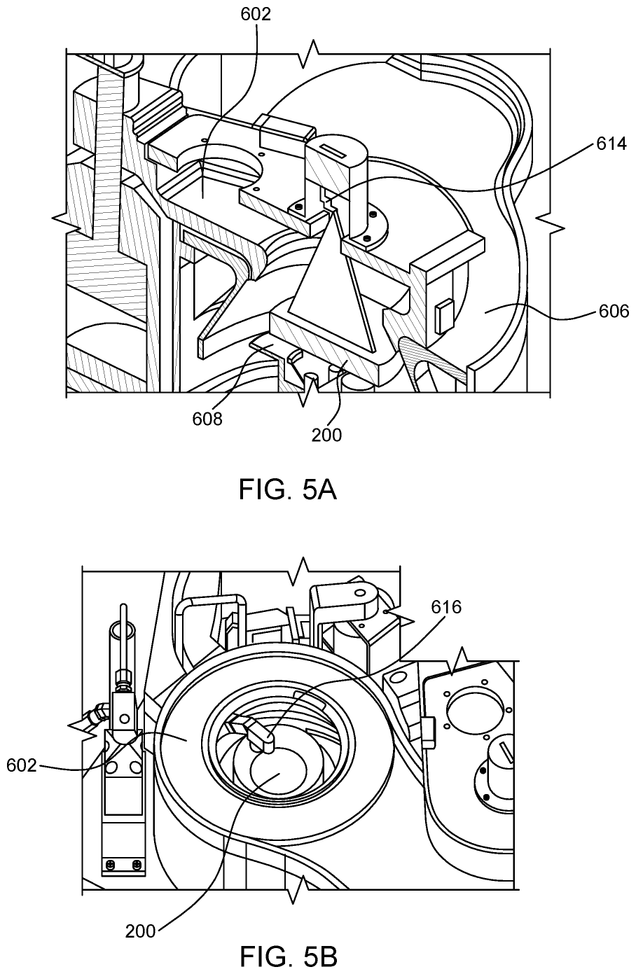

With continued reference to FIGS. 3-4, the washing and drying station 600 has at least one wash nozzle 614 configured for cleaning at least one surface of the optical article 200 with a liquid, such as distilled or deionized water. In some examples or aspects, the at least one wash nozzle 614 may be configured for discharging the liquid under pressure onto at least one surface of the optical article 200 under pressure. The at least one wash nozzle 614 may be movable between a first or stowed position (FIG. 3), in which the at least one wash nozzle 614 is moved out of the way to permit loading and unloading of the optical article 200 onto the spin platform 608, and a second or deployed position (FIG. 5A), in which the at least one wash nozzle 614 is positioned over at least a portion of the optical article 200 for washing the at least one surface of the optical article 200. In this manner the entire upper surface and edge of the optical article 200 can be cleaned, such as with deionized water under conditions of elevated pressure, such as about 1,000 psi, with some examples. The rotatable chuck 612 can rotate during spray washing to assure even cleaning of the optical article 200. In some examples or aspects, a final rinse nozzle 615 may be provided for a final, low pressure rinsing of the optical article 200. The final rinse nozzle 615 desirably operates at a lower pressure than the at least one wash nozzle 614. The washing parameters, such as liquid pressure, washing time, and rotating speed can be programmable and can vary based on parameters, such as the type and/or size of the optical article 200, plasma treatment, and/or subsequent coating processes.

With reference to FIG. 5B, the washing and drying station 600 has at least one cleaning brush 616 configured for physically cleaning at least one surface of the optical article 200. The at least one cleaning brush 616 may be movable between a first or stowed position (FIG. 4), in which the at least one cleaning brush 616 is moved out of the way to permit loading and unloading of the optical article 200 onto the spin platform 608, and a second or deployed position (FIG. 5B), in which the at least one cleaning brush 616 is positioned over at least a portion of the optical article 200 for contacting at least one surface of the optical article 200. The at least one cleaning brush 616 may have a plurality of bristles configured for scouring the surface of the optical article 200. The at least one cleaning brush 616 may be rotatable. In some examples or aspects, the at least one cleaning brush 616 may have a nozzle configured for spraying liquid during the brushing process. In this manner, the entire upper surface and edge of the optical article 200 can be cleaned. The rotatable chuck 612 can rotate during bushing to assure even cleaning of the optical article 200. In some examples, the optical article 200 may be sprayed with liquid from the at least one wash nozzle 614 or the final rinse nozzle 615 after the brushing process is completed.

Following washing, the optical article 200 can, with some examples, be dried in the washing and drying station 600 by one or more drying methods including, but not limited to, high speed rotation of the spin platform 608 and/or high speed air nozzle(s). In some examples or aspects, and with reference to FIG. 4, the wash bowl 604 may have an air inlet 618 configured for directing air toward the spin platform 608, an air outlet 620 configured for exhausting the air from the wash bowl 604, and a diffuser 622 between the air inlet 618 and the air outlet 620. The diffuser 622 is configured to direct air from the air inlet 618 toward the air outlet 620 in a laminar manner. The drying parameters can be programmed in a manner similar to those associated with the washing parameters, with some examples.

With reference to FIG. 1, the surface-treated and cleaned optical article 200 can be transferred to the coating apparatus 300 for applying one or more coatings to at least one surface of the optical article 200. The coating apparatus 300 may be a plurality of coating apparatuses 300. In some examples or aspects, the placement arm 900 may be configured for moving the optical article 200 from the washing and drying station 600 to the coating apparatus 300. The one or more coatings may be applied on at least one surface of the optical article 200 using a number of different techniques. In some examples or aspects, the optical article 200 may be immersed into a liquid coating material. After the optical article is pulled out of the liquid, the liquid coating material forms a coating layer on the immersed surface(s) of the optical article 200. In other examples or aspects, as disclosed herein, a liquid coating material is deposited onto a surface of the optical article 200, which is then rotated at high speed to spread the coating material into a thin film covering the surface of the optical article 200. In further examples or aspects, the coating apparatus 300 may be an inkjet printing apparatus that is configured to apply a coating material in the form of extremely fine droplets on a printing surface, such as one or more surfaces of the optical article 200. In various examples or aspects, the coating apparatus 300 may be configured for applying a uniform coating or a gradient coating on at least one surface of the optical article 200.

Following washing and drying of the optical article 200, the placement arm 900 reengages the optical article 200 and moves it to the at least one coating apparatus 300. The placement arm 900 may position the optical article 200 in the at least one coating apparatus 300 at a predetermined orientation relative to the at least one coating apparatus 300 based on the orientation of the at least one mark 210 and/or the information contained in the at least one mark 210. The placement arm 900 may move the optical article 200 to the inspection apparatus 800 prior to positioning the optical article 200 in the at least one coating apparatus 300 in order to determine the orientation of the at least one mark 200 and/or the information contained in the at least one mark 210. For example, the optical article 200 may be arranged such that the at least one mark 210 is substantially parallel, perpendicular, or arranged in any other orientation relative to a direction in which a coating material is applied to the optical article 200 using the coating apparatus 300. In this manner, the proper orientation of the optical article 200 can be maintained during application of, for example, a gradient coating.

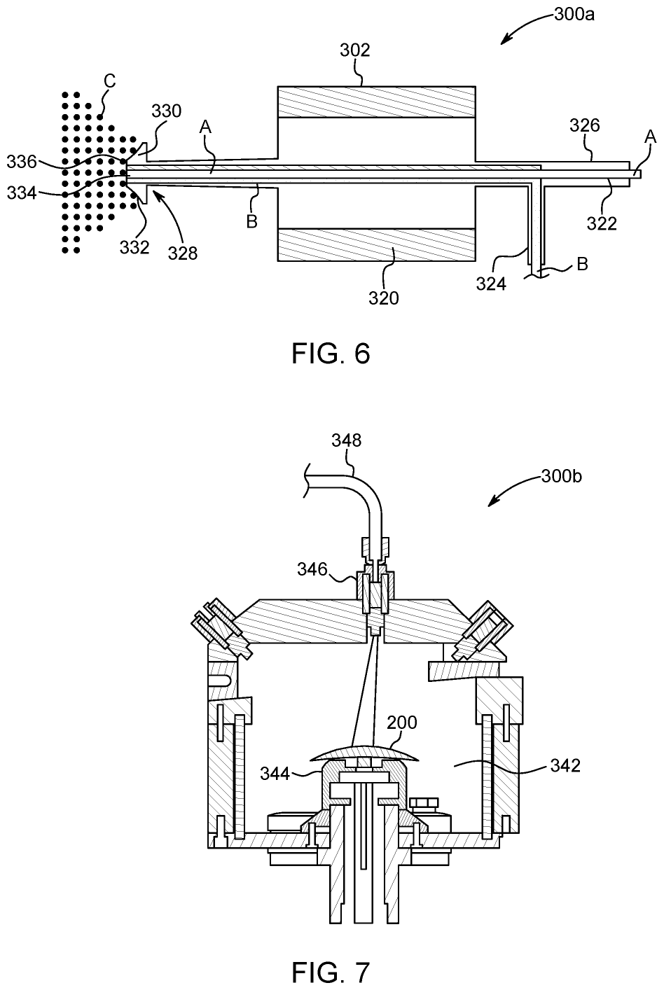

In some examples, the coating apparatus 300 may have a plurality of coating apparatuses 300. The plurality of coating apparatuses 300 may be the same type of coating apparatuses (i.e., ultrasonic spray apparatus), or different type of coating apparatuses, such as, without limitation, inkjet coating apparatuses, spin coating apparatuses, and dip coating apparatuses. With reference to FIG. 6, a first coating apparatus 300a may be embodied as an ultrasonic discharge nozzle 302 which is configured for applying a coating material in the form of fine droplets. With reference to FIG. 7, a second coating apparatus 300b, such as a spin coating apparatus may be configured for applying a coating material onto a previously coated or uncoated optical article 200. Following the processing of the optical article 200 in one or more stations of the coating system 100, such as the washing and drying station 600 or the first coating apparatus 300a, the optical article 200 may be moved the second coating apparatus 200, such as using the placement arm 900, for application of an additional coating layer.

With reference to FIG. 6, ultrasonic spray coating (atomization) technology is a process by which high frequency sound waves are utilized to produce an atomized spray liquid. For example, a metal diaphragm vibrating at an ultrasonic frequency may be employed to create atomized liquid droplets. The resultant droplets may be precisely targeted toward a surface to be coated. Ultrasonic atomization, as employed according to various examples of the present invention, advantageously has been found to assist in imparting improved process control and precise, uniform thin film coatings for lenses. A controller may control the size of the drop (volume of coating material) and the speed at which the drop is formed and delivered.

With continued reference to FIG. 6, an exemplary ultrasonic discharge nozzle 302 has a housing 320 with at least one liquid feed channel extending through the housing 320. The housing 320 has a diaphragm (not shown) that vibrates at an ultrasonic frequency to create atomized liquid droplets. In some examples, the housing 320 has a first liquid channel 322 and a second liquid channel 324 extending therethrough. The first liquid channel 322 and the second liquid channel 324 extend substantially parallel to one another through the housing 320. In some examples, the first liquid channel 322 and the second liquid channel 324 may be coaxial such that one of the first liquid channel 322 and the second liquid channel 324 extends through a bore of the other of the first liquid channel 322 and the second liquid channel 324. Each of the first liquid channel 322 and the second liquid channel 324 has a first end 326 opposite a second end 328 along a longitudinal axis. The first end 326 of each of the first liquid channel 322 and the second liquid channel 324 is in fluid communication with a coating material storage system, as described herein.

With continued reference to FIG. 6, the second end 328 of the first liquid channel 322 and the second liquid channel 324 terminates in a nozzle 330 having an atomizing surface 332. The nozzle 330 has a first outlet 334 for delivering fluid through the first liquid channel 322 and a second outlet 336 for delivering fluid through the second liquid channel 322. In some examples, the first outlet 334 may be configured for delivering the first coating material through the first liquid channel 322, while the second outlet 336 may be configured for delivering one or more additional coating materials through the second liquid channel 322. As the first coating material and the one or more additional coating materials are delivered to the atomizing surface 332 of the nozzle 330, the coating materials mix at the nozzle 330 and are atomized by the ultrasonic vibration of the ultrasonic discharge nozzle 302 into an atomized mixture C prior to being deposited on a coating surface of the optical article 10.

In various examples or aspects, the one or more ultrasonic discharge nozzles 302 may be controlled to apply uniform or non-uniform thickness of a coated layer in a controlled, predetermined pattern of atomized droplets. For example, the one or more ultrasonic discharge nozzles 302 may apply a coating having a substantially uniform thickness over an entire coating surface of the optical article 200.

In some examples, a plurality of ultrasonic discharge nozzles 302 may be arranged in an array. The plurality of ultrasonic discharge nozzles 302 may be arranged parallel to one another in a direction that is angled relative to a direction in which the plurality of ultrasonic discharge nozzles 302 are moved relative to the optical article 200. Offsetting the ultrasonic discharge nozzles 302 at an angle allows a complete coverage of optical article 200 of various shapes and sizes. In other examples, the ultrasonic discharge nozzles 302 may be arranged linearly next to one another in a direction substantially parallel or perpendicular to the direction in which the ultrasonic discharge nozzles 302 are moved relative to the optical article 200.

With reference to FIG. 7, the second coating apparatus 300b may be a spin coating apparatus having a coater bowl 342, which can be a rotatable vacuum chuck 344 with some embodiments. The rotatable chuck 344 is configured to receive the optical article 200 within coater bowl 342 and is configured to rotate the optical article 200 during coating, the speed and timing of which can vary depending upon parameters including, but not limited to, the coating and optical article 200. At least one dispense nozzle 346 is configured for dispensing a select amount of the coating material onto the top surface of the optical article 200, preferably in a center portion of the top surface of the optical article 200. The coating material is evenly spread across the top surface of the optical article 200 during high-speed rotation of the optical article 200 on the rotatable vacuum chuck 344. The dispense nozzle 346 may be connected to a coating material storage system via a supply line 348.

The coater bowl 302 is configured to collect excess coating material expelled from the optical article 200 that is coated therein, and/or cleaning materials that are periodically utilized to clean coater bowl 302 (such as at the end of the week, or day, or shift). The second coating apparatus 300b of the present invention is effective as a once through system for small scale production, with some embodiments.

With reference to FIG. 1, each coating apparatus 300 is in fluid communication with a coating material storage system 1000 (hereinafter referred to as “storage system 1000”). The storage system 1000 is configured for containing the coating material and selectively supplying the coating material to each coating apparatus 300 during a coating application process. In some examples or aspects, the storage system 1000 may contain a single coating material that is selectively supplied to each coating apparatus 300 during the coating application process. In other examples or aspects, the storage system 1000 may contain a plurality of different coating materials, each of which can be independently selected and supplied to each coating apparatus 300 during the coating application process. In this manner, a plurality of coating materials may be supplied to each coating apparatus 300 to create a desired mixture of the coating materials.

The coating material can, with some examples, include a curable resin composition, and optionally, a solvent. The coating material can be in the form of art-recognized liquid coating materials and powder coating materials. The coating material can be thermoplastic, radiation curable such as by ultraviolet radiation or electron beam, or thermosetting coating material. With some examples, the coating materials are selected from curable or thermosetting coating materials. Coating materials can include kinetic enhancing additives, photoinitiators, and thermal initiators. With some examples, coating materials can include a static dye, a photochromic material, or a combination thereof. Alternatively or additionally, the optical article 200 can include a static dye, a photochromic material, or a combination thereof. Various coating materials can be used for applying primer coatings and films; protective coatings and films, including transitional coatings and films and abrasion resistant coatings and films; anti-reflective coatings and films; polarizing coatings and films; and combinations thereof.

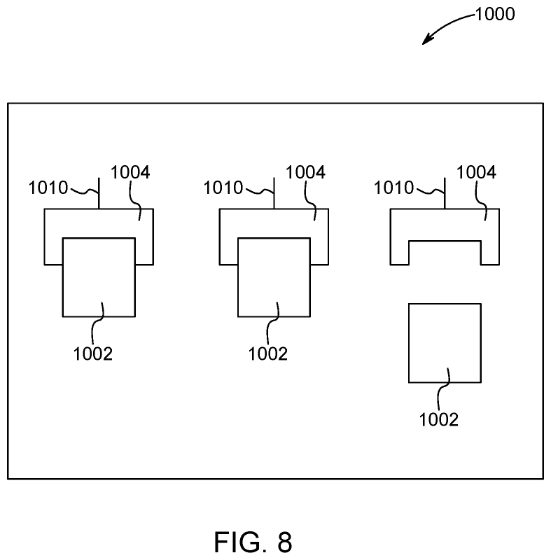

With reference to FIG. 8, the storage system 1000 may have at least one replaceable cartridge 1002. Each replaceable cartridge 1002 of the storage system 1000 may be configured for containing the coating material, recirculating the coating material in a recirculation loop, and selectively dispensing a desired amount of coating material to the coating apparatus 300. In some examples or aspects, a plurality of replaceable cartridges 1002 are provided. Each replaceable cartridge 1002 may contain a different coating material. In some examples or aspects, at least some of the plurality of replaceable cartridges 1002 may contain the same coating material.

With continued reference to FIG. 8, each replaceable cartridge 1002 can be removed from the storage system 1000 for cleaning, refilling, and servicing. For example, the storage system 1000 may have a plurality of bays 1004, each of which is configured to receive a single replaceable cartridge 1002. Each bay 1004 has a first pneumatic connector 1006 and a first electric connector 1008 configured for connecting to the corresponding pneumatic and electric connectors on the replaceable cartridge 1002. In this manner, each replaceable cartridge 1002 can be quickly and easily connected to or disconnected from the respective bay 1004 of the storage system 1000. In some examples or aspects, inserting the replaceable cartridge 1002 into the bay 1004 may automatically establish a pneumatic and electric connection between the replaceable cartridge 1002 and the storage system 1000. In other examples or aspects, pneumatic and electrical connections between the replaceable cartridge 1002 and the bay 1004 can be done separately after inserting the replaceable cartridge 1002 into the bay 1004. Similarly, removing the replaceable cartridge 1002 from the bay 1004 may automatically disconnect the pneumatic and electric connections between the replaceable cartridge 1002 and the storage system 1000. In other examples or aspects, pneumatic and electrical connections between the replaceable cartridge 1002 and the bay 1004 can be disconnected separately prior to or after removal of the replaceable cartridge 1002 from the bay 1004.

With continued reference to FIG. 8, when connected to the bay 1004 of the storage system 1000, each replaceable cartridge 1002 may be fluidly connected to a delivery line 1010 configured to deliver the coating material from the replaceable cartridge 1002 to the at least one coating apparatus 300. In some examples or aspects, each replaceable cartridge 1002, when connected to the respective bay 1004, may be connected to the at least one coating apparatus 300 via a dedicated delivery line 1010. In other examples or aspects, delivery lines 1010 from each replaceable cartridge 1002 may be connected to a manifold that is then connected to the at least one coating apparatus 300.

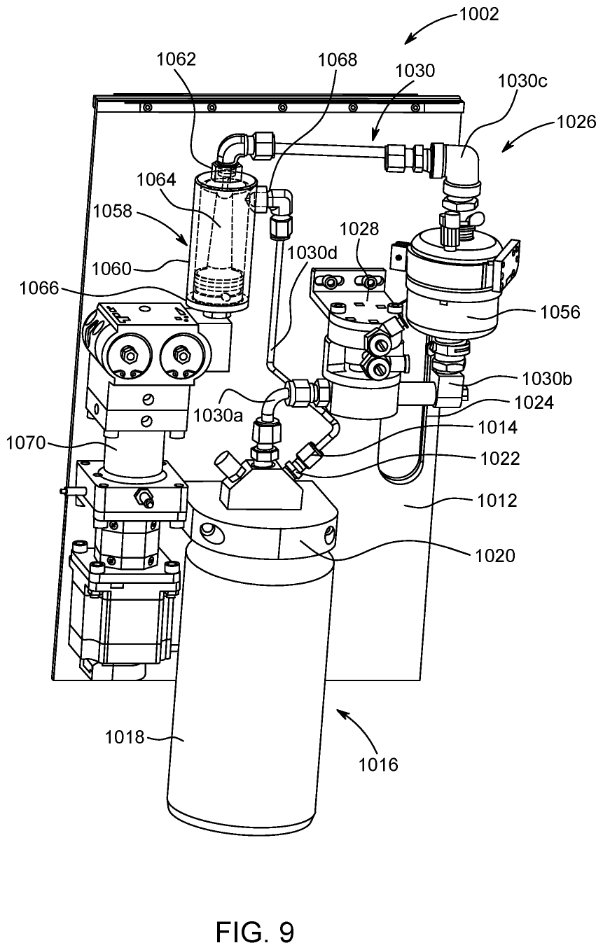

With reference to FIG. 9, the replaceable cartridge 1002 has a frame 1012 configured for supporting various components for containing the coating material, recirculating the coating material in a recirculation loop, and selectively dispensing a desired amount of coating material to the coating apparatus 300. The frame 1012 may be configured to removably or non-removably support the various components. In some examples or aspects, the frame 1012 may be configured for interacting with the bay 1004, such as by having at least one side that is slidably engagable with at least a portion of the bay 1004. The frame 1012 can, in some examples or aspects, be a planar material having a sufficient thickness to support the various components configured for containing the coating material, recirculating the coating material in a recirculation loop, and selectively dispensing a desired amount of coating material to the coating apparatus 300. The frame 1012 can be made from a metal material, a plastic material, or a combination of metal and plastic materials. In some examples or aspects, the frame 1012 may have a handle 1014 for handling the frame 1012 during removal of the frame 1012 from the bay 1004 and/or insertion of the frame 1012 into the bay 1004.

With continued reference to FIG. 9, the replaceable cartridge 1002 has a reservoir 1016 configured for containing a volume of a coating material. In some examples or aspects, the reservoir 1016 has a storage portion 1018 defining an interior for containing the coating material, and a cap 1020 that is removably connectable to the storage portion 1018 and is configured for enclosing the interior of the storage portion 1018. At least one of the storage portion 1018 and the cap 1020 may be removably connected to the frame 1012. In some examples or aspects, the reservoir 1016 may have a volume of IL to 20L. The coating material inside the reservoir 1016 may be kept at ambient pressure, a vacuum pressure, or a positive pressure.

In some examples or aspects, the storage portion 1018 may be a conventional coating reservoir that is provided by a manufacturer of the coating material. Such a storage portion 1018 may be removably connectable to cap 1020. In this manner, the storage portion 1018 may be discarded after the coating material is used up and a new storage portion 1018 filled with the coating material can be connected to the cap 1020. In other examples or aspects, the storage portion 1018 may be re-fillable with the coating material after the coating material is used up.

With continued reference to FIG. 9, the cap 1020 has an outlet 1022 configured for delivering the coating material out of the storage portion 1018 and an inlet 1024 configured for returning the coating material into the storage portion 1018. The outlet 1022 and inlet 1024 are connected to a recirculation loop 1026 that is configured for circulating the coating material from the reservoir 1016 using a first pump 1028. In some examples or aspects, the recirculation loop 1026 comprises tubing 1030 having a first end connected to the outlet 1022 and a second end connected to the inlet 1024. In this manner, the recirculation loop 1026 is in fluid communication with the reservoir 1016. Various additional elements may be disposed in-line with the tubing 1030 between the first end and the second end such that these additional elements are in fluid communication with the recirculation loop 1026, as described herein. When additional elements are provided in-line with the tubing 1030, the tubing 1030 may comprise a plurality of tubing segments interconnecting the various elements and being in fluid communication with each other.

With continued reference to FIG. 9, the replaceable cartridge 1002 has the first pump 1028 in-line with the recirculation loop 1028. The first pump 1028 is connected to the outlet 1022 of the reservoir 1016 via a first tubing segment 1030a. In some embodiments or aspects, the first pump 1028 may be configured to aspirate the coating material from the reservoir 1016 and pump the coating material through the recirculation loop 1026 to be delivered back into the storage portion 1018 via the inlet 1024 or to be delivered to the at least one coating apparatus 300 via a second pump, as described herein. In some examples or aspects, the first pump 1028 may be configured to continuously circulate the coating material through the recirculation loop 1016 while the replaceable cartridge 1002 is connected to the coating system 100. In this manner, the coating material is continuously mixed to prevent separation of solids and to extend the life of the coating material.

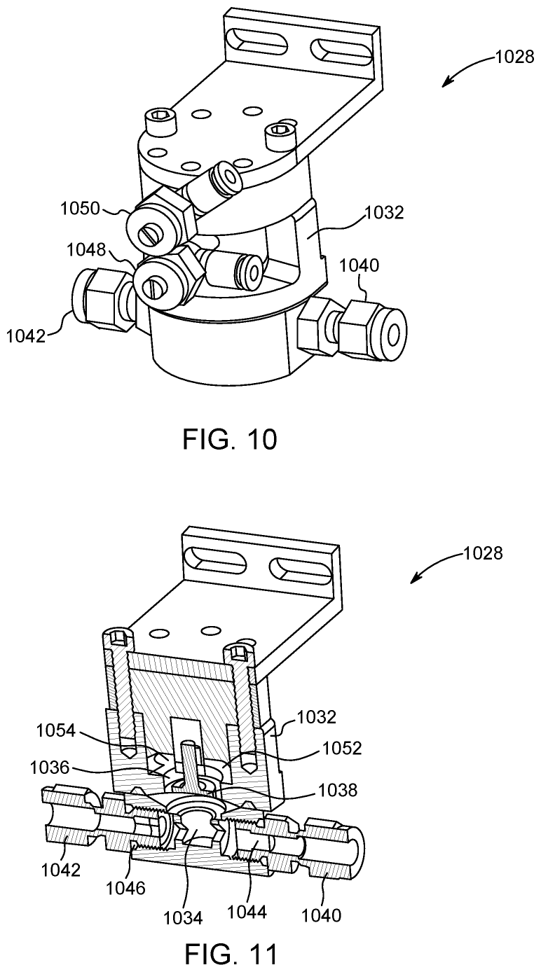

With reference to FIGS. 10-11, the first pump 1028 is a diaphragm pump configured for recirculating the coating material from the reservoir 1016 through the recirculation loop 1026. In some examples or aspects, the first pump 1028 may be any other kind of pump that is configured for continuously recirculating the coating material from the reservoir 1016 through the recirculation loop 1026. When embodied as a diaphragm pump, and as shown in FIG. 11, the first pump 1028 includes a housing 1032 having a first chamber 1034 and a second chamber 1036 in fluid isolation from the first chamber 1034 via a flexible membrane 1038. The flexible membrane 1038 is configured to deflect in response to a pressure differential between the first chamber 1034 and the second chamber 1036. In this manner, by controlling the pressure differential across the chambers 1034, 1036, the first pump 1028 can pump the coating material.

With continued reference to FIGS. 10-11, the first pump 1028 further includes a liquid inlet 1040 and a liquid outlet 1042 in fluid communication with the first chamber 1034. The liquid inlet 1040 has a liquid inlet check valve 1044 and the liquid outlet 1042 has a liquid outlet check valve 1046. The liquid inlet check valve 1044 and the liquid outlet check valve 1046 may be one-way check valves configured to permit flow in a first direction and prevent flow in a second direction opposite to the first direction. The first pump 1028 further includes an air inlet 1048 and an air outlet 1050 in fluid communication with the second chamber 1036. In some examples or aspects, the air inlet 1048 has an air inlet check valve 1052 operable between an air inlet open positon and an air inlet closed position and the air outlet 1050 has an air outlet check valve 1054 operable between an air outlet open positon and an air outlet closed position. Similar to the liquid inlet and outlet check valves 1044, 1044, the air inlet check valve 1052 and the air outlet check valve 1054 may be one-way check valves configured to permit flow in a first direction and prevent flow in a second direction opposite to the first direction.

In some examples or aspects, the air inlet check valve 1052 may be operable between the air inlet open positon and the air inlet closed position independent of operation of the air outlet check valve 1054 between the air outlet open positon and the air outlet closed position. For example, a controller 1100 (shown in FIG. 1) may be provided for controlling independent operation of the air inlet check valve 1052 and the air outlet check valve 1054. By controlling the state of the air inlet check valve 1052 and the air outlet check valve 1054, pressure in the second chamber 1036 can be controlled to, in turn, control the position of the flexible membrane 1038. In this manner, by controlling a position of the flexible membrane 1038, liquid coating composition can be pumped through the first chamber 1034.

With reference to FIG. 9, the replaceable cartridge 1002 has a filter 1056 positioned in-line and in fluid communication with the recirculation loop 1028. The filter 1056 may be positioned downstream of the first pump 1028 and may be connected to the liquid outlet 1042 of the first pump 1028 via a second tubing segment 1030b. The filter 1056 may be configured for filtering the coating material circulating through the recirculation loop 1026.

With reference to FIG. 9, the replaceable cartridge 1002 has a de-bubbling system 1058 positioned in-line and in fluid communication with the recirculation loop 1028. The de-bubbling system 1058 may be positioned downstream of the filter 1056 and may be connected to the filter 1056 via a third tubing segment 1030c. The de-bubbling system 1058 may be configured for removing air bubbles in the coating material circulating through the recirculation loop 1026.

With continued reference to FIG. 9, the de-bubbling system 1058 has a chamber 1060 configured for receiving the coating material from the filter 1056 via the third tubing segment 1030c. The third tubing segment 1030c may be connected to a first end 1062 of the chamber 1060. A conical separator 1064 is positioned within the chamber 1060 and is configured for attracting any air bubbles in the coating material as the coating material flows down the conical separator 1064. The attracted air bubbles are dislodged from the conical separator 1064 and float toward the first end 1062 of the chamber 1060. A second end 1066 of the chamber 1060 is positioned at an inlet of the second pump, as described herein. As the coating material fills the chamber 1060, the level of the coating material in the chamber 1060 rises in a direction from the second end 1066 toward the first end 1062. A chamber outlet 1068 is provided in a sidewall of the chamber 1060 proximate to the first end 1062. The chamber outlet 1068 is in fluid communication with the reservoir 1026 via a fourth tubing segment 130d. In this manner, de-bubbled coating material can be returned from the de-bubbling system 1058 into the reservoir 1026 via the fourth tubing segment 1030d.

With continued reference to FIG. 9, the replaceable cartridge 1002 has a second pump 1070 positioned in-line and in fluid communication with the recirculation loop 1028. The second pump 1070 is connected to the second end 1066 of the de-bubbling system 1058 and is configured to aspirate the coating material from the chamber 1060 of the de-bubbling system 1058. In some embodiments or aspects, the second pump 1070 is operable to aspirate a select amount of the coating material from the recirculation loop 1026, such as from the de-bubbling system 1058, and deliver the select amount of the coating material to the at least one coating apparatus 300.

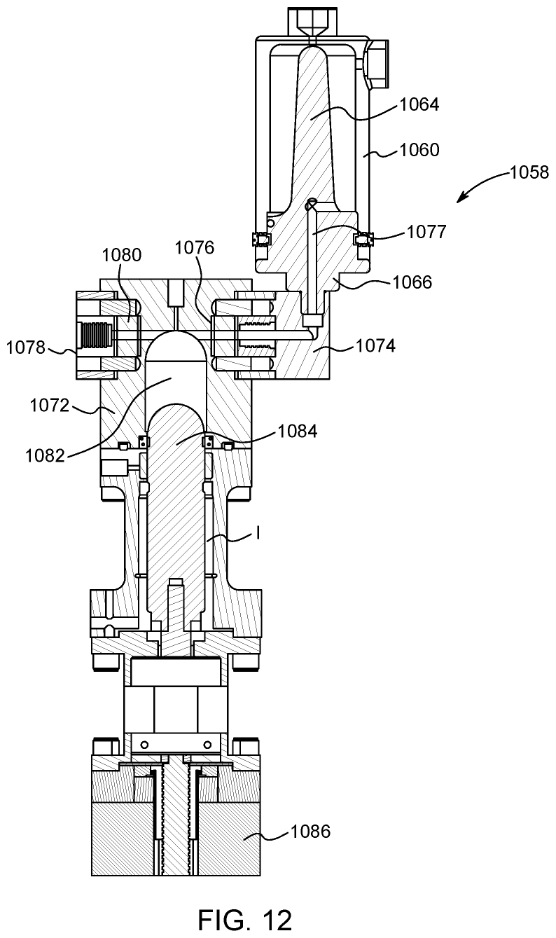

With reference to FIG. 12, the second pump 1070 may be a piston pump. In some examples or aspects, the second pump 1070 may be any other kind of pump that is configured for aspirating a select amount of the coating material from the recirculation loop 1026 and delivering the coating material to the at least one coating apparatus 300. When embodied as a piston pump, the second pump 1070 includes a housing 1072 having an inlet 1074 with an inlet valve 1076, an outlet 1078 having an outlet valve 1080, and a pumping chamber 1082 between the inlet valve 1076 and the outlet valve 1080. The inlet valve 1076 is in fluid communication with the recirculation loop 1026, such as via an inlet tube 1077 connected to the de-bubbling system 1058 while the outlet valve 1080 is in fluid communication with the at least one coating apparatus 300. The piston pump 1070 further includes a piston 1084 disposed within the pumping chamber 1082 and configured for reciprocal movement within the pumping chamber 1082 via a drive member 1086. The drive member 1086 may include an actuator configured for reciprocally moving the piston 1084. In some examples or aspects, the actuator may be a stepper motor. A controller may be configured to control operation of the actuator to accurately dispense a select amount of the coating material from the recirculation loop 1026 and deliver the coating material to the at least one coating apparatus 300. In some examples or aspects, each replaceable cartridge 1002 may have various additional devices, such as heaters, mixers, or the like, may be associated with each replaceable cartridge 1002 for preparing the coating material prior to delivery to the at least one coating apparatus 300.

With reference to FIG. 1, the coating system 100 has the curing station 401 having at least one curing apparatus 400, wherein each curing apparatus is independently configured to at least partially cure the at least one coating material applied to the optical article 200. Following the application of the desired coating material to at least one surface of the optical article 200, the placement arm 900 may be configured to move the optical article 200 to the curing station 401. With some examples or aspects, the curing station 401 includes at least one of: (i) a thermal curing apparatus; (ii) a UV curing apparatus; (iii) an IR curing apparatus; and (iv) combinations of at least two of (i), (ii), and (iii).

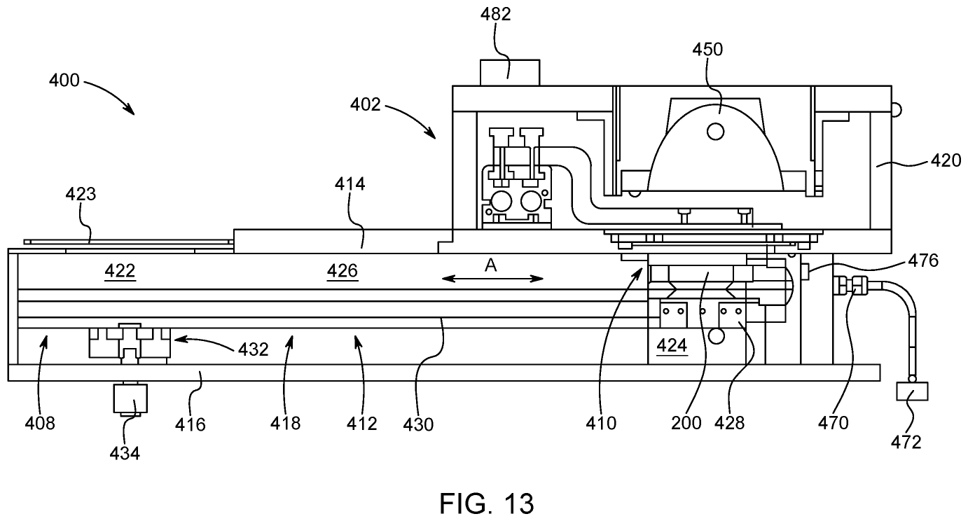

With reference to FIG. 13, the curing apparatus 400 that is embodied as a UV curing apparatus is shown in accordance with some examples or aspects of the present disclosure. The curing apparatus 400 has a housing 402 defining a loading portion 408 that is open to ambient atmosphere, a curing portion 410 having a controlled atmosphere, and a transition portion 412 extending between the loading portion 408 and the curing portion 410. The loading portion 408, the curing portion 410, and the transition portion 412 define separate chambers within an interior 418 of the housing 402. The loading portion 408 has a loading chamber 422 configured for receiving an optical article 200 during loading and loading. The loading portion 408 is open to ambient atmosphere and may be enclosed by a door 423. The curing portion 410 has a curing chamber 424 having the controlled atmosphere for curing the optical article 200. The loading chamber 422 and the curing chamber 424 are connected to each other via a transition chamber 426 of the transition portion 412.

With continued reference to FIG. 13, the curing apparatus 400 includes a carrier 428 movable between the loading chamber 422 and the curing chamber 424 via the transition chamber 426. The carrier 428 is movable between the loading chamber 422 and the curing chamber 424 on a rail 430 in a direction of arrow A in FIG. 13. The carrier 428 is supported on an upper portion of the rail 430 and is movable between the loading chamber 422 and the curing chamber 424 via a transfer mechanism 432. As described herein, the carrier 128 is configured for supporting the optical article 200 for moving the optical article 200 between the loading portion 408 and the curing portion 410.

In some examples or aspects, the transfer mechanism 432 includes a drive element 434, such as a motor, a linear actuator, or a rotary actuator that is operatively connected to the carrier 428. The carrier 428 may be operatively connected to the drive element 434 via a belt, chain, rod, or other mechanical connection. Actuation of the transfer mechanism 432 may be controlled by a controller, as described hereinafter, and results in movement of the carrier 428.

With continued reference to FIG. 13, the curing apparatus 400 has at least one ultraviolet radiation source 450 (hereinafter referred to “UV source 450”) operative for transmitting ultraviolet (UV) radiation into the curing chamber 424. The at least one UV source 450 is positioned such that at least a portion of the UV radiation emitted therefrom is incident on at least one surface of the optical article 200 when the optical article 200 is positioned in the curing chamber 424. In some examples, the at least one ultraviolet radiation source 450 may be an ultraviolet lamp having at least one bulb, such as a mercury bulb, configured for emitting radiation within the ultraviolet spectrum. The specifications of the at least one ultraviolet radiation source 450 may be selected depending on a type of coating to be cured.

With reference to FIG. 13, the curing chamber 424 of the curing apparatus 400 may have an atmosphere that is different from the atmosphere outside the curing chamber 424. In some examples or aspects, the curing chamber 424 may have an inert atmosphere due to increased concentration of an inert gas, such as nitrogen or one or more noble gases. Without intending to be bound by theory, it has been found that curing of the coating covering the optical article 200 can be significantly improved when the coating is cured in a controlled and inert atmosphere that is different from ambient atmosphere. With continued reference to FIG. 13, at least one nozzle 470 may be provided for delivering the inert gas into the curing chamber 424. The at least one nozzle 470 is in communication with a vessel 472 containing the inert gas. At least one sensor 476 may be provided for detecting a concentration of the inert gas in the curing chamber 424. Output from the at least one sensor 476 may be used for adjusting a flow rate of the inert gas through the at least one nozzle 470 to maintain the concentration of the inert gas at a predetermined level.

In some examples or aspects, the curing apparatus 400 may be embodied as an IR curing apparatus that includes an appropriate IR source. In further examples, the curing apparatus 400 may be embodied as a thermal curing apparatus having a thermal oven. The thermal oven can, with some examples, be an electric oven and/or a gas fired oven (such as a natural gas fired oven). With some examples or aspects, a coated and cured optical article 200 can be returned from the curing apparatus 400 to: (i) the washing and drying station 600; and/or (ii) the coating apparatus 300 for the application of a subsequent coating material. The cured optical article 200 can, with some examples, be moved via the placement arm 900 to an accumulation area 490 for final inspection and/or packing.

With reference to FIG. 1, the coating system 100 has at least one controller 1100 operatively connected to at least one component of the coating system 100. In some examples or aspects, the at least one controller 1100 may be configured to control operation of at least one component of the coating apparatus 300, the curing apparatus 400, the pre-treatment station 500, the washing and drying station 600, the marking apparatus 700, the inspection apparatus, 800, the placement arm 900, and the at least one replaceable cartridge 1000. In other examples or aspects, separate controllers 1100 may be provided for each of the coating apparatus 300, the curing apparatus 400, the pre-treatment station 500, the washing and drying station 600, the marking apparatus 700, the inspection apparatus, 800, the placement arm 900, and the at least one replaceable cartridge 1000.

In some examples or aspects, the at least one controller 1100 may be a microprocessor controller. The at least one controller 1100 may be configured for pulse width modulated (PWM) operation, wherein analog operation of at least one component of the coating apparatus 300, the curing apparatus 400, the pre-treatment station 500, the washing and drying station 600, the marking apparatus 700, the inspection apparatus, 800, the placement arm 900, and the at least one replaceable cartridge 1000 can be achieved using digital control signals. In some examples or aspects, the at least one controller 1100 may be configured for continuously modulated control of at least one component of the coating apparatus 300, the curing apparatus 400, the pre-treatment station 500, the washing and drying station 600, the marking apparatus 700, the inspection apparatus, 800, the placement arm 900, and the at least one replaceable cartridge 1000. The at least one controller 1100 may have memory configured for storing one or more predetermined automated processes. In some examples or aspects, the at least one controller 1100 may be configured for operating on a 110V or a 220V AC power circuit, and/or on battery power. In other examples or aspects, the at least one controller 1100 may be configured for operating on a 12V DC power circuit.

The present invention has been described with reference to specific details of particular examples thereof. It is not intended that such details be regarded as limitations upon the scope of the invention except insofar as and to the extent that they are included in the accompanying claims.

1. A coating system for coating an optical article, the coating system comprising:
at least one replaceable cartridge comprising a reservoir configured for containing a volume of a coating material, a recirculation loop in fluid communication with the reservoir, and a first pump and a second pump in fluid communication with the recirculation loop; and
at least one coating apparatus operable to coat at least a portion of the optical article with a select amount of the coating material from an engaged at least one replaceable cartridge,
wherein the second pump of each of the engaged at least one replaceable cartridge is operable to aspirate the select amount of the coating material from the recirculation loop and deliver the select amount of the coating material to the at least one coating apparatus.

2. The coating system according to claim 1, wherein the first pump is a diaphragm pump configured for recirculating the coating material from the reservoir through the recirculation loop.

3. The coating system according to claim 1, wherein the second pump is a piston pump comprising a piston disposed within a pumping chamber and configured for reciprocal movement within the pumping chamber via a drive member.

4. The coating system according to claim 1, wherein the at least one coating apparatus comprises a first coating apparatus and a second coating apparatus each selectively operable to coat at least a portion of the optical article with the select amount of the coating material from the engaged at least one coating reservoir.

5. The coating system according to claim 4, wherein the first coating apparatus comprises an ultrasonic discharge nozzle configured for atomizing the select amount of coating material from the engaged at least one coating reservoir.

6. The coating system according to claim 4, wherein the second coating apparatus is a spin coating apparatus.

7. The coating system according to claim 1, further comprising a marking apparatus configured for marking at least one surface of the optical article with at least one mark; and an identification apparatus configured for identifying the at least one mark, wherein the at least one mark contains information for processing the optical article in the coating system.

8. The coating system according to claim 7, further comprising a placement arm configured to move the optical article from the identification apparatus to the at least one coating apparatus and position the optical article at a predetermined orientation relative to at least one coating apparatus based on the orientation of the at least one mark.

9. The coating system according to claim 1, further comprising a pre-treatment station, wherein the pre-treatment station is configured for raising wettability of the optical article to promote adhesion of the at least one coating material with the optical article.

10. The coating system according to claim 1, further comprising a cleaning station comprising:
a housing having a wash bowl and a lid for enclosing the wash bowl;
a spin platform within the wash bowl configured for receiving the optical article; and
at least one wash nozzle configured for cleaning at least one surface of the optical article with a pressurized liquid.

11. The coating system according to claim 10, wherein the wash bowl comprises an air inlet configured for directing air toward the spin platform, an air outlet configured for exhausting the air from the wash bowl, and a diffuser between the air inlet and the air outlet.

12. The coating system according to claim 1, further comprising at least one curing station, where each curing station is independently configured to at least partially cure the at least one coating material applied to the optical article.

13. The coating system according to claim 12, wherein each curing station independently comprises at least one of (i) a thermal curing station; (ii) a UV curing station; (iii) an IR curing station; or (iv) combinations of at least two of (i), (ii), and (iii).

14. The coating system according to claim 1, further comprising a filter in fluid communication with the recirculation loop, wherein the filter is configured for filtering the coating material circulating through the recirculation loop.

15. The coating system according to claim 1, further comprising a de-bubbling system in fluid communication with the recirculation loop, the de-bubbling system configured for removing air bubbles in the coating material circulating through the recirculation loop.
